(19) United States
(12) Patent Application Publication
(10) Pub. No.: US 2004/0255000 A1
(43) Pub. Date: Dec. 16, 2004

(54) Remotely controlled failsafe boot mechanism and remote manager for a network device

(76) Inventors: Dan C. Simionescu, Bucharest (RO); Liviu G. Ionescu, Bucharest (RO)

Correspondence Address: DARBY & DARBY P.C., P. O. BOX 5257, NEW YORK, NY, 10150-5257, US

(21) Appl. No.: 10/491,695

(22) PCT Filed: Oct. 3, 2002
(86) PCT No.: PCT/US02/31499

Related U.S. Application Data
(60) Provisional application No. 60/327,158, filed on Oct. 3, 2001.

(51) Int. Cl. G06F 15/16

(52) U.S. Cl. 709/208

(57) ABSTRACT

Increased availability, reliability and security are enable in a network device by providing remote control over the boot mechanism of a host machine. Methods for providing secure operation of a network device are also described.

This patent application claims priority from U.S. Provisional Application Ser. No. 60/327,158, filed Oct. 3, 2001, entitled “REMOTELY CONTROLLED FAILSAFE BOOT MECHANISM AND MANAGER FOR A NETWORK DEVICE”, the entirety of which is hereby incorporated by reference.

### FIELD OF THE INVENTION

The present invention generally relates to remote management. The invention relates more specifically to a method and apparatus for enabling full remote control over the startup phase, and over the configuration and maintenance procedures of a computer. It is applicable to network servers, network appliances and any other devices providing services over a communication network (like the Internet).

### BACKGROUND OF THE INVENTION

With the ever-increasing integration of network services in business operations, including business-critical applications, most, if not all businesses have become highly dependent on the reliability and availability of the network infrastructure. To best ensure a reliable network infrastructure, full remote control of the network devices is necessary. For example, points of presence (“POPs”) added to expanding networks are generally controlled from a central network operation center (NOC) and cyber centers are often used to house network devices for multiple customers, with each customer managing their respective network devices from their own premises.

At one end of the spectrum, conventional network devices range from general purpose server computers to dedicated network appliances. General purpose server computers utilize conventional circuitry and operating systems that utilize a BIOS boot mechanism on start-up. Ordinarily, the BIOS scans through a list of attached devices and attempts to boot. Disk-like devices (hard disk, floppy, CD, Disk-On-Chip) dedicate the first sector of their first track as the boot sector; the BIOS loads a short segment of code from the boot sector into the computer's RAM and executes that code. The boot code causes secondary loader code to be stored into RAM. The secondary loader code enables the computer to access attached file systems and load the kernel of the computer's operating system for execution. This arrangement permits a variety of operating systems to be loaded, and allows for ready upgrading and maintenance. To protect against failures, mirrored hard disks are provided to store the file systems. However this configuration does little to protect against boot failures caused by information corruption, which can occur due to physical damage, software problems or malicious attacks. In these circumstances, human intervention is typically required at the site of the server. Some high performance machines, however, provide an expansion board allowing remote access to the motherboard keyboard/VGA/mouse ports through a maintenance network, permitting access to the BIOS setup sufficient to boot the server from a network image. Maintenance is then performed by the remote operator using common methods.

By having all maintenance tools installed on the publicly accessible device, this architecture also provides a pathway for an intruder to gain privileged control over the server, with potentially devastating consequences.

FIG. 1 shows a typical setup for a server computer 50 in which the operating system, applications, maintenance tools and bootstrap code 52 are loaded from a hard-disk storage 54 into RAM 215. The general public accesses the server 50 through a communication link 56 to a public network 58. The server 50 is susceptible both to failure and external attacks and therefore must be constantly monitored, for example, from a console 60 connected to a private port over a communication line 62. A component failure or external attack can compromise the integrity of the operating system, applications, and maintenance tools. Either of these circumstances can frustrate the administrator's ability to restore desired operation of the server 50.

At the opposite end of the spectrum are dedicated network appliances with embedded systems. These devices are typically designed to perform specific tasks, and can boot directly from a read only memory (ROM) device, or perhaps from a flash memory (which permits on-board reprogramming). Flash memory is more flexible than ROM because it allows for software upgrades. However, any interruption during an upgrade can place the appliance in an unstable state, making recovery tedious and sometimes requiring operator intervention to restore functionality. Although these devices are generally reliable, when disasters strike the general availability of services provided is adversely affected. These appliances are associated with high cost due to their special purpose design and reduced ability to be upgraded or expanded, but, from a functional point of view, there are many applications in which they are far superior to using a general-purpose server. A classic example is that of routers, which evolved from general-purpose servers configured to perform IP routing, to dedicated appliances that can do only routing; with minimal but carefully balanced hardware resources, these appliances obtain maximum performance and reliability.

Ideally, any server should have its software installed, maintained, upgraded, monitored and configured through a secure management domain, with no critical services available through its public interfaces. An administrator should be able to do all maintenance remotely, in a simple manner, regardless of software failures on the server or boot device failures. Also, the server should have its core programs, operating system and configurations stored on reliable, solid state devices managed by a highly available management unit. The present invention provides an improved failsafe boot mechanism and manager which satisfies these and other needs.

### SUMMARY OF THE INVENTION

The present invention introduces a new approach that aims to preserve the low cost and versatility of general-purpose servers while featuring the reliability of dedicated network appliances and adding secure and failsafe remote operability. This is accomplished by augmenting a general-purpose server (the host) with a device (the master) that assumes full control over the boot mechanism and operation of the host.

In accordance with one aspect of the invention, a method for providing a secure operation of a host computer comprises the steps of connecting a master device to (at least one) the host computer, the master device having a CPU configured to execute a monitor program and to manage one or more host images and the host computer. The bootstrap code native to the host computer is bypassed and instead a master-device supplied bootstrap code is executed. A communication channel is established between the master device and the host computer, with communications therebetween being governed by the CPU of the master device. A selected one of the host images is transferred from the master device over the communication channel to the host computer, and the host computer is instructed to execute the transferred host image. The functionality of the host computer is actively monitored by the monitor program by comparing a set of operational parameters obtained from the host computer against a prescribed set of values within a prescribed period of time.

In accordance with this first aspect of the invention, on the basis of the monitored comparison, the host computer is selectively restarted to thereby maintain the secure operation of the host computer.

In accordance with another aspect of the invention, one or more active processes are executed on the host computer while the master device determines if any of the active processes is operating outside of prescribed parameters. On the basis of the determining step, one or more of the active processes rather then the entire host computer is selectively restarted to thereby maintain a secure operation of the host computer.

Various other aspects, features and advantages of the invention can be appreciated from the drawing figures and description of certain illustrative embodiments.

### BRIEF DESCRIPTION OF THE DRAWINGS

FIG. 1 is a block diagram of a prior art server computer system in which basic operational software is loaded from hard-disk storage into RAM.

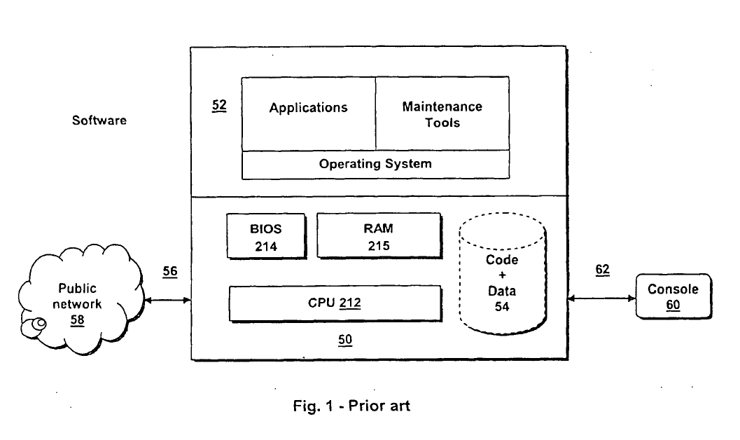

FIG. 2 is a block diagram of a network device according to a preferred embodiment of the invention in which the operating system and applications are loaded into RAM of the network device from solid state storage of an external master device. In this embodiment, the maintenance tools reside on the master device.

FIG. 3 is a block diagram of the main hardware components of a master device constructed in accordance with the preferred embodiment.

FIG. 4 is a state diagram of the start-up modes of the master device of the preferred embodiment.

FIG. 5 illustrates a start-up cycle of a master device of the preferred embodiment.

FIG. 6 illustrates operation of the master device of the preferred embodiment, including the operation of the microcontroller.

FIG. 7 illustrates operation of the host computer in accordance with the invention.

FIG. 8 is a block diagram of the master and host configuration mechanism.

FIG. 9 is a block diagram showing a stacked API configuration.

FIG. 10 illustrates a first configuration for a server farm having plural host computers and corresponding master devices.

FIG. 11 illustrates a second configuration for a server farm having plural host computers and a standalone master device.

### DETAILED DESCRIPTION OF CERTAIN ILLUSTRATIVE EMBODIMENTS

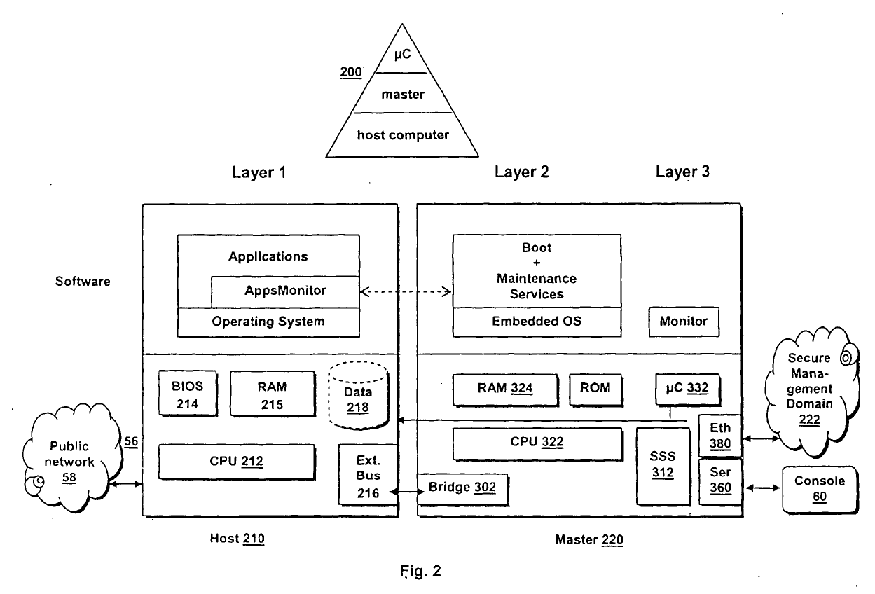

By way of overview and introduction, the invention is described in connection with a preferred embodiment thereof, as illustrated generally in FIG. 2. In the preferred embodiment, a multilayered architecture 200 imparts high availability, high reliability and high security to a host computer 210 using a master device 220 which is provided with option R [symbol] code that is executed preferentially and in lieu of the boot code from the BIOS 214 of the host computer 210. Consequently, the master device 220 assumes control over the host computer's boot mechanism via the host extension bus 216.

Host Computer

FIG. 2 illustrates a preferred multilayer architecture 200 for controlling the boot operation and actively monitoring the well-being of the host computer 210. The three layers are: the host computer, the master device and the microcontroller. The host computer 210 is at a base layer in the architecture, and includes a central processing unit (CPU) 212, basic input/output software (BIOS or monitor) 214, random access memory (RAM) 215, and an extension bus 216. The host computer 210 can comprise a machine from any one of a variety of manufacturers as long as the extension bus 216 permits a master device 220 to take control upon reset and load and start the host computer's operating system and application software. One suitable extension bus 216 is the PCI bus developed by Intel Corporation and now managed by a consortium of industry partners known as the PCI Special Interest Group, Portland Oreg. The PCI bus is included in all modern PC-compatible machines manufactured by IBM Corporation of Armonk, N.Y., Hewlett Packard of Palo Alto, Calif., Dell Computer Corporation of Austin, Tex., and in most non PC-compatible machines manufactured by Sun Microsystems of Palo Alto, Calif., Apple Computer of Cupertino, Calif., to name a few. The host computer 210 includes a communication link 56 through a communication port to a public network 58, and one or more devices connected to the extension bus (e.g., a mass storage device such as hard disk drive 218). The host 210 may include other hardware and drivers which are not pertinent to the present invention.

In accordance with a preferred embodiment, a master device 220 is connectable to the host computer 210 through the extension bus 216 and governs the boot process of the host computer, thereby serving as an embedded middle layer in the tiered architecture of the present invention. The master device 220 includes a controller, preferably in the form of a microcontroller 332, which, in connection with a watchdog circuit, monitors the operation of the master as well as the on/off status of the host computer. The microcontroller 332 sits at the top of the hierarchy as it has the ability to restart both the host computer and the master device. As described below, the master device 220 includes a CPU 322 that actively monitors the well-being of the host, provides a full remote maintenance path and automatically initiates the restart of the network device if a software problem or an improper state change is detected in the host computer (when implemented as an add-on board in the host computer, restarting the host computer usually implies restarting the master device too). The effective restart of the network device is performed by the microcontroller 332 either upon request from the CPU 322 or automatically if the heartbeat from the CPU 322 is no longer received within a prescribed period of time. This architecture thereby provides a degree of reliability and integrity that cannot be achieved through conventional architectures.

At startup the host computer 210 executes a BIOS 214 that allows an external device to execute a boot code from an option ROM in lieu of the native bootstrap procedure. As a result, an independent operating system is booted. For example, suitable operating systems that can be employed include Unix-based systems such as FreeBSD or Linux and the Windows NT operating system. These operating systems can each implement a driver for communication with the master device 220 over the extension bus 216, and permit alteration of the bootstrap procedure to skip disk loading of system components, accepting instead those loaded by the master device 220. The master device 220 can load a host image which can generate a RAM disk with the root file system of the operating system. If the networking component of the host computer's operating system includes an Internet Protocol security (IPsec) layer then computing intensive operations like encryption, decryption, public key generation, compression and decompression can be referred to a security processor 390 associated with the master device 220.

If the host software supports use of a serial console, the serial console can be linked to an auxiliary serial port on the master device 220 (see FIG. 2) to direct console messages from the host computer to the master device and to allow remote control for the early startup phases, like BIOS setup. Alternatively, the master device 220 can communicate through an extension bus 216 of the host computer using a peer driver that runs in the host software. Such drivers provide host console redirection, host syslog message forwarding and can be used by the master device for controlling and configuring the host computer.

The main host software module is AppsMonitor which starts and monitors the host applications, sends configuration information to the master device 220 ConfigService software module, and enables remote configurability of the host computer by way of the master device 220. This software is described below.

Master Device

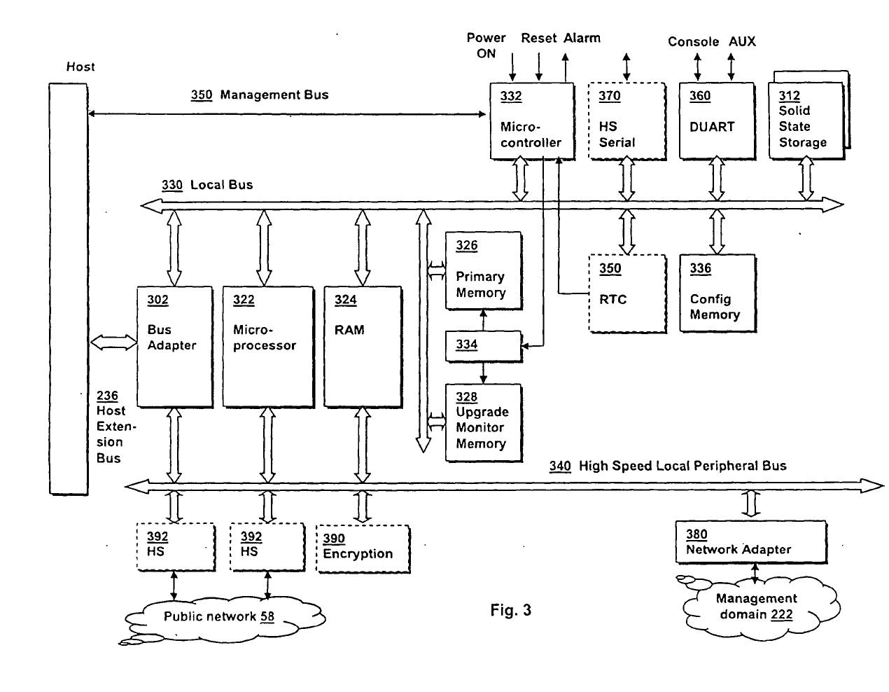

The master device 220 of the preferred embodiment is constructed on a PCI board that can be plugged in to an industry standard PCI bus such as the extension bus 216 of the host computer. The PCI board is fit with a highly-integrated chipset that implements the functionality of many of the blocks illustrated in FIG. 3. Preferably, however, solid state storage 312 is removably seated on the PCI board. The components of the master device are discussed next, followed by a description of the operation of the master device.

The master device 220 operates autonomously using a microprocessor 322 that accesses RAM 324, programmable primary non-volatile memory 326, upgrade monitor non-volatile memory 328, and peripheral devices connected to a local bus 330 or a high-speed local bus 340. For example, the Intel i960 family processors of Intel Corporation, Santa Clara, Calif., can be used as the microprocessor 322. A bus adapter 302 connects the host computer's extension bus 216 to the local peripheral bus 330 and to the high-speed local bus 340. In the preferred embodiment in which the extension bus 216 is a PCI bus, the bus adaptor 302 performs PCI-to-PCI bridge functions and, together with the microprocessor 322, address translation functions. These functions, however, can be performed within the microprocessor 322 if it supports that functionality.

The master device 220 uses the RAM 324 as workspace for local processing and monitoring operations. In addition, the master device includes a primary non-volatile memory 326 which contains the firmware of the master device (operating system and services) and governs the operation of the master. Preferably, primary memory 326 is a fast flash memory. The primary memory 326 is programmable to permit upgrades and modifications to the master device to suit user needs. However, a controlled sequence is required to place the master device 220 in a mode that permits the primary memory 326 to be reprogrammed. Moreover, the primary memory 326 can only be reprogrammed if the microcontroller 332 places the master device in an upgrade mode (described next), and then only through a console.

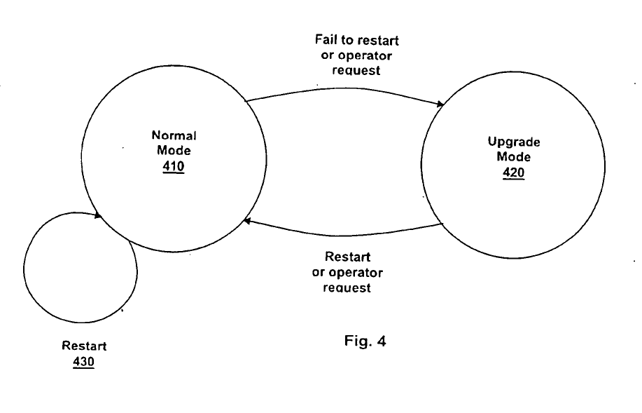

In order to place the primary memory 326 into a reprogrammable mode, the master device must change its state of operation from a normal mode 410 to a upgrade mode 420, as shown in the state diagram of FIG. 4. Under normal mode operation, the master device 220 executes code from the primary memory 326 or from RAM 324. Each time the master device is restarted, it remains in the normal mode, as shown by looping arrow 430. The microcontroller 332 monitors the microprocessor 322 and the embedded operating system and will automatically reset the entire network device in case of a failure. The monitoring function includes a watchdog circuit that checks for latch-up or a lack of an expected heartbeat to monitor the functionality of the master device 220. The microcontroller 332 also monitors and decides conditions for changing the state of operation between the normal mode 410 and the upgrade mode 420. At reset, the microcontroller 332 sends a reset signal to the motherboard of the host computer 210 that also resets the master device 220. The microcontroller provides a signal to a selection logic module 334 to affect a selection between the primary memory 326 and the upgrade monitor memory 328 during the software upgrade of the primary memory 326 of the master device 220. In addition, the microcontroller 332 controls the programming voltage to the primary memory 326 when in the upgrade monitor mode. The selection logic module 334 is preferably a custom integrated circuit that includes a decoder circuit, an upgrade monitor, and compact upgrade code in what is known as “glue logic.” Typically, these functions are included in an ASIC device. The compact upgrade monitor code enables the CPU 322 to access any peripheral device connected to the master for purposes of facilitating reprogramming of the primary memory 326 in the upgrade monitor mode 420. The microcontroller is preferably powered by a standby power supply.

Preferably, the upgrade monitor memory 328 is a factory-programmed ROM, for example, an 8-bit flash memory, and so on-board reprogramming is not possible and the master device 220, therefore, has a failsafe start-up mode. The upgrade monitor code, when executed, configures the microprocessor 322 so that the primary memory 326 can be updated (that is, reprogrammed). The microcontroller 332 automatically defaults to the upgrade mode 42U it the attempt to start in normal mode fails (usually due to a failed upgrade, leaving an inappropriate content of the primary memory 326).

The upgrade monitor code provides intentionally unsophisticated and preferably bug-free code that provides commands to download files from a remote storage device (via a simple protocol like TFTP) and remotely reprogram the primary memory 326. Access to the microprocessor 322 for reprogramming the primary memory 326 is only possible by connecting through the serial console. To prevent accidental or unauthorized alteration of the code in the primary memory 326, it can be reprogrammed only in upgrade mode 420 (i.e., when started from the upgrade monitor memory 328).

Thus, the only mechanism for transferring an image into the master device's solid state storage 312 is through a private domain or console. The master device 220 provides a gateway for managing a public machine assigned to it (e.g., the host 210). The master device 220 controls the data transfer from the host computer 210 across the extension bus 216. No data or action from the host computer can alter the master device's 220 RAM 324, primary memory 326 upgrade monitor memory 328 or solid state storage 312. Even if data transferred into the master device affected its operation, the onboard watchdog circuit will cause a restart of both the master device and the host computer once the change in operating conditions is detected.

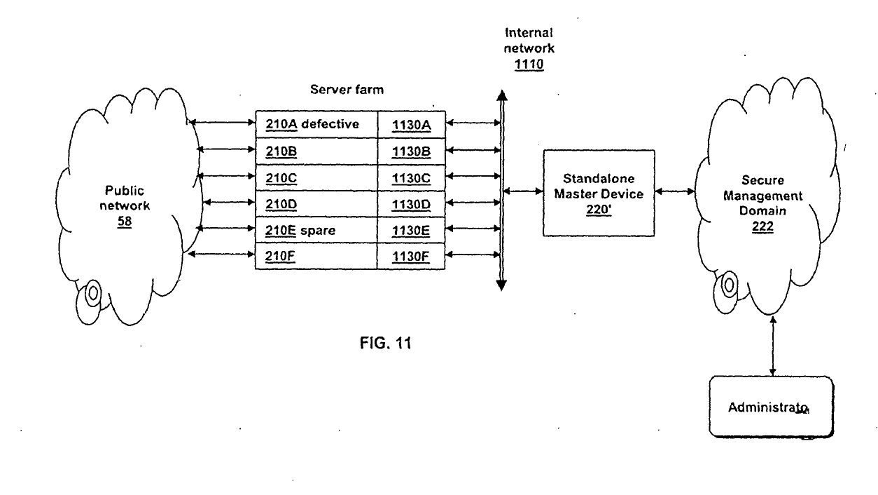

In the embodiment described in connection with FIGS. 2-10, the master device 220 is physically connected to the extension bus 216 of a given host computer 210. In this arrangement, the master device is “assigned” to a given host computer through the physical connection across the extension bus, and there is a one-to-one correspondence between host computers and master devices. However, the invention can be embodied in other forms (see FIG. 11) in which a given master device 220′ can be dynamically assigned to a host computer 210 through dedicated internal network in which the sharable master device connects to its host through a managed high speed network adapter 1130. This alternative configuration permits an administrator to remotely “assign” (connect, swap, replace, etc.) a given master device 220′ to a selected host computer, and does not require a physical re-connection of that master device to the selected host computer by disconnecting and reconnecting the master device to an appropriate extension bus. In this arrangement the master device is “assigned” to one or many host computers.

The master device 220 governs the boot process of the host computer 210 by injecting directly or indirectly (via a fast communication mechanism) into the host computer's RAM 215 the code and data needed to establish a desired configuration of applications and operating system. Such code and data is preferably provided as a single image file and resides in the solid state storage 312. The host image permits startup of the host computer 210 under the control of the master device 220 free of any other resources such as hard disk drives, so that the start-up process is maximally reliable. As such, the solid state storage 312 stores the host computer's 210 software image, the startup configuration and custom files and can be implemented for example using CompactFlash, MultiMedia Card or Secure Digital card. The startup configuration specifies which image the host will execute. In a basic configuration, the image in module 312 needs only contain an executable file that loads into the host's RAM 215 and executes without any prior processing as a monotask standalone application. In a more complex configuration, the image is a structured archive that can contain, in the case of a Unix-like system, a kernel adapted for booting with a memory root file system, with the rest of the archive including the basic files needed by the operating system plus any files needed by the host applications in the desired configuration. Use of structured archives has the advantage that complex systems can be built with relative ease using standard tools (such as tar and gzip) and standard operating system and application files.

An optional real-time clock (RTC) 350 provides clock signals to the components connected to the local bus 330, including the microcontroller 332. The RTC 350 has a rechargeable battery as a back-up power source to ensure uninterrupted operation of the clock. The RTC 350 can provide a wake-up function in which an interrupt signal can be provided to the microcontroller 332 to initiate a power-up sequence. The microcontroller 332, in turn, is powered from a standby (exterior) power source to ensure that the microcontroller 332 has power even if the host computer 210 powered down. A motherboard reset signal or a power-on signal can be generated and provided by the microcontroller either via a management bus 350 (e.g. IPMB) or through suitable relays, solenoids, semiconductors or the like that actuate respective buttons on the front panel of the host computer 210. This arrangement also permits the microcontroller 332 to restart the host computer 210 (and, in turn, the master device 220) in response to the wake-up command from the RTC 350 even if the host computer was in a power-off state. Thus, an administrator can program the master device 220 to turn on the host computer (if not already powered on) at prescribed intervals and thereby ensure that the host computer 210 is in a power on state without having to make a site visit to the location of the host computer. In addtion to scheduled power-on, the network device can react to Wake-on-Lan packets received from the management domain and power up the entire network device.

The printed circuit board of the master device 220 preferably includes a non-volatile memory 336 which provides configuration data to the other hardware components on the circuit board and, if space allows, the full startup configuration. Preferably, the memory 336 is serial EEPROM device. Dual serial ports 360 are preferably included for communication with a console device and for use as an auxiliary port. Preferably, a network adapter port 380 is used locally by the master device 220 to connect to the secure management domain 240 through which an administrator can control the master device 220 and the host computer 210.

Optionally, the master device 220 further includes a high speed serial interface 370 for connecting custom external devices, and a security processor 390 programmed to provide hardware-accelerated data encryption and compression. The security processor 390 can be used either by the host computer 210 or the master device 220 for speeding up encryption, decryption, public key generation, compression and decompression tasks involved in securing network communication, for instance in IPsec. Also, the master device can be provided with additional high speed ports 392, if desired. Any high speed devices connected to the high speed ports 392 communicate with the master device through the high speed local bus 340. The host computer can access and communicate with such devices through the bus adapter 302 via the extension bus 216; however, the microprocessor 322 programs the bus adaptor 302 to reserve the network adapter port 380 for the master device 220 alone, thus disabling the host computer 210 from accessing it. This feature physically isolates the (private) management domain from the public domain under the control of the master device 220.

The devices 302 up to 370 communicate with the microprocessor 322 and with one another on the local bus 330. The local bus can comprise a number of buses having a variety of bandwidths, speeds, and technologies (e.g., 8-bit, 32-bit, 12C, etc.) The network adapter port 380, which permits communication with the management domain 240 is preferably on the high speed bus 340, together with the encryption security processor 390 and any high speed ports 392. In another preferred embodiment the master device 220 can be integrated into the circuitry on the host's 210 mainboard, preferably using highly integrated custom integrated circuits. The optional devices 392, 390, 370 and 350 can be excluded.

Master Device Software Modules

The master device 220 executes an embedded operating system on the microprocessor 322 and supports multiple threads, TCP/IP stack, solid-state file system, network adapter and other serial ports drivers, and a communication driver for communication with the host computer 210. The software modules utilized by the master device are stored in the primary memory 326 and/or in the solid state storage 312 and can take on a variety of forms, as understood by those of skill in the art.

There is a boot manager module that serves together with the option ROM code to load a selected image from the solid state storage module 312 into the memory 215 of the host computer. Multiple images can be stored in the storage module 312, each with different operating systems and/or applications, and one of these images can be selected, for example, on the basis of the startup configuration data of the machine to which the master device has been assigned. The boot manager together with the option ROM code assists the host computer during the host's bootstrap procedure by monitoring and governing the host computer's boot process. The boot manager can selectively restart the host computer 210 if that action is determined by other circuitry as being necessary or desired.

In another embodiment of the invention, the master device is constructed so that it can be assigned to one or many different hosts having different configurations and executing different images. The selection of the appropriate operating system and applications for the intended host can be made according to the startup configuration of the master device or on the basis of a command received from the management domain through a communication link.

There is also a command line editor (CLI) module that provides command line access to the master device 220. The CLI permits control and configuration of applications of the host computer 210 and services on the master device 220. Access can be by a serial line, telnet, ssh Secure Protocol or other protocol. The CLI module additionally provides a console output service for use by all the other active services.

A web server module provides access into the master device 220 to control and configure the master device's services and the applications of the host computer 210. A simple network management protocol (SNMP) agent provides SNMP access to control and configure these services and applications through the (private) management domain.

A “ConfigService” module enables user authentication for access and use of the CLI and web server module and also enables configuration of the services available on the master device and configuration of the applications running on the host computer. ConfigService also enables a particular configuration to be saved to the storage module 312 or another remote storage device and enables a particular configuration to be retrieved from the storage module 312 or another remote storage device. ConfigService further includes parameters or permissions that the master device 220 must satisfy, can send messages to the administrator, and generally maintains the configuration of the master device 220.

A command parser module permits commands issued by the ConfigService, CLI and web server modules to be parsed. A system log service module provides a system log forwarding service for use by other services. A network utility module provides a number of conventional, network monitoring utilities such as ping and trace route. A time service module provides time services for use by other services. Also, a fetch configuration module is preferably provided to retrieve configuration files on behalf of the host 210 from remote storage devices (e.g., using file transfer protocol (FTP) or TFTP), to maintain a local cache of the fetched files, and for backup purposes in case the network is down and configuration data cannot be retrieved from another remote storage device.

Another software module associated with the operation of ConfigService on the master device is an application monitor (“AppsMonitor”); however, the AppsMonitor module is resident in the host computer and is included in the host image. AppsMonitor starts or stops and monitors the host applications. AppsMonitor enables the remote configurability of the host applications via the master device 220. AppsMonitor provides signals to the master device, such as a heartbeat indicative of operation of the host computer's CPU and responds to ‘is Alive’ requests and other signals upon which the master device can act if necessary. Apps [symbol] monitors the well-being of the host computer by monitoring the applications and collecting data on the health of the host (like process status, resource utilization, etc). The data collected is compared against a prescribed criterion and, if not within specifications, a predetermined action is taken. The actions that can be taken by the master device include:

1. warning an administrator of the violation (e.g., through messaging or log entries),

2. terminating or restarting the violative process,

3. terminating or restarting the host computer, and

4. a combination of the above.

Distributed Architectures

In the basic embodiment of the invention, the functional relationship between the master and the host is such that the master is neutral to the operating system that runs on the host. However, for extremely secure environments, the functional relationship can be tightened such that, in general, only user-mode code runs on the host computer while parts of or all kernel data and code is managed and/or run by the master. In such cases, all system activity (like process creation, resources utilization, etc) can be strictly controlled by the master and any illegal requests or attempts to compromise security can be accounted and processed accordingly.

Having the memory map under its own control, the master device can also periodically test if the memory pages of the host are still consistent (for example if the read-only pages have identical content with their originals stored in the host image). This can be achieved by creating a map of CRC values when initially unpacking the image and periodically checking those values versus the CRC of actual memory pages). It should be understood, however, that, in this case, the code running on the master needs to be extended with specific host operating system functionality.

Start-Up and Operation

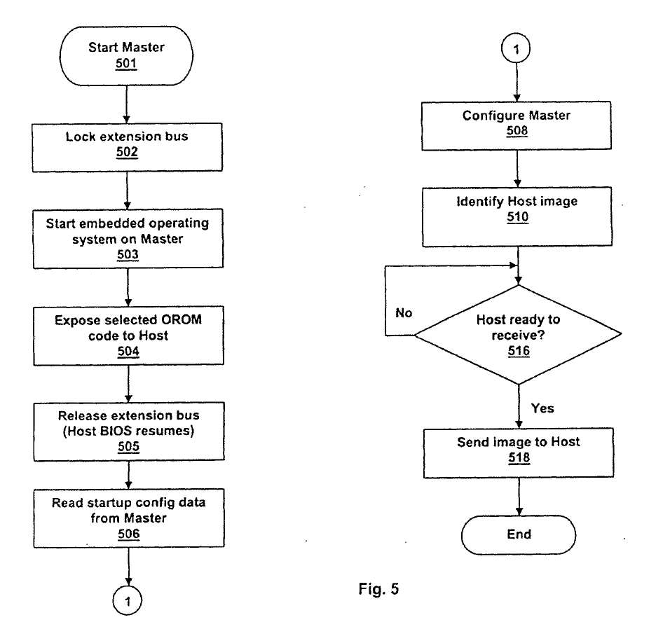

Upon reset or power on, both the host computer 210 and the master device 220 each undergo respective startup routines. With reference now to FIG. 5, the operation of the master device is explained in connection with a cold start of the host computer and master device.

Because the master device 220 can be connected to host computers with different performance, the two devices typically have different length start-up cycles. The master device utilizes hardware logic provided by the bus adapter 302 to hold the host extension bus 216 of the host computer as well as its firmware 214 (e.g., monitor or BIOS) in a locked state until the bus is released, as indicated at step 505. The bus is held until the master device is self-configured and until its OROM code is exposed to the host computer 210. In this manner, the master device can ensure that it is operational and executing all necessary code before the host computer attempts to execute its native boot code.

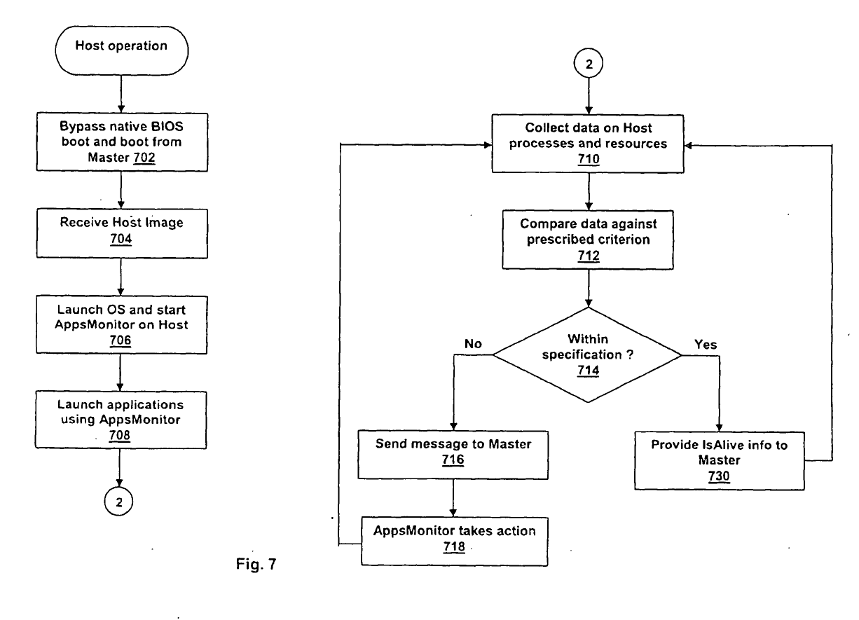

The master device 210 starts by executing a native (embedded) operating system from code stored in the primary memory 326, at step 503. At step 504, the master device exposes a portion of its memory 324 or 326 as an option ROM (OROM) to the CPU 212 of the host computer 210 using the address translation functions of the bus adapter 302. The master device 220 then releases the host extension bus 216 at step 505 now that it is configured and ready to transfer a software image into the RAM 215 of the host computer. Configuration data for the master device is read at step 506 from configuration memory 326 and either from on-board storage such as one of several storage modules 312, or from a remote storage device, preferably connected to the high speed local peripheral bus 340. The master device configures itself using that information at step 508. At step 510, the master device identifies an image to be transferred to the assigned host computer 210 and checks it for consistency. Ordinarily, the assigned host computer is the host computer 210 to which the master device 220 is connected; however, the master device can be assigned to a different host computer than the one to which it is directly attached in accordance with other embodiments and methods of the invention. The master device then awaits a signal from the host computer 210 that the boot procedure can start, as indicated at step 516. Once the extension bus has been released, the host computer continues executing code from the firmware 214 (monitor or BIOS). Part of the firmware includes power on self tests (POST) code, and during execution of the POST code, the host computer assesses the devices connected to its motherboard and learns, among other things, that the master device 220 is present. The master device is registered as the first boot device. The master device and host computer can have their communications synchronized simply by using a shared memory area, for example. The host computer completes execution of the POST code and then passes control back to the OROM of the master device. As a result, the native boot code in the bios 214 within the host computer 210 is bypassed in favor of executing the OROM boot code of the master device 220 (step 702 of FIG. 7). Essentially, the OROM boot code of the master device is a BIOS extension for the host computer to which it is plugged in.

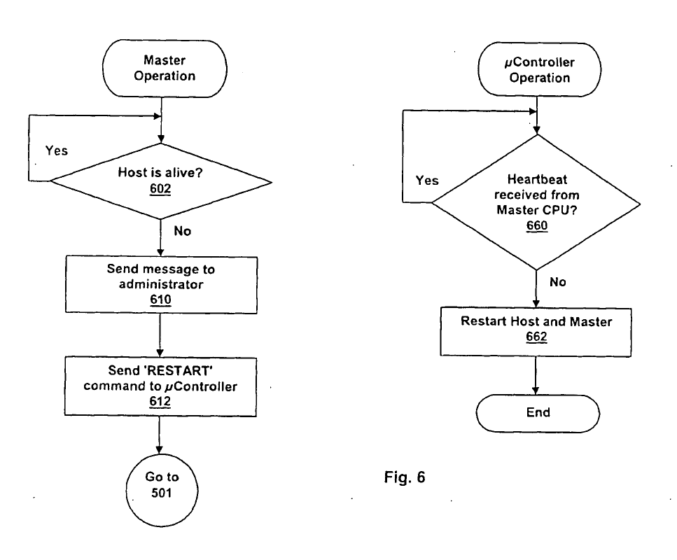

The OROM boot code causes the CPU 212 to communicate with the CPU 322 to read and download (transfer) a preselected image to the RAM 215 of the host computer. Preferably, the image is transferred from the storage module 312, as indicated at step 518. The image transfer is across the extension bus 216. The transfer step can proceed in one of two ways. Preferably, the OROM code 324 instructs the CPU 212 of the host computer to download the image into the host's RAM 215 while permitting the host to manage the download, decompression, and decryption processes, as necessary. If the image is encrypted, the master device transfers decryption keys or other data that permits decryption within the host computer. This provides the advantage of utilizing the processing power of the host computer. Alternatively, the OROM boot code 324 can instruct the CPU 322 to permit the master device 220 to load the host's RAM 215 with the preselected software image (i.e., with the operating system, applications and tools to be executed on that host computer). In this mode, the download is managed by the CPU 322 of the master device, as well as any decompression/decryption of the transferred image. Preferably, the “image” transferred to the host computer comprises a compressed (and optionally encrypted) version of the operating system and applications that are to run on the host computer 210. If the transferred image is a full image, that is, includes the operating system and applications, then the master device can remain in an idle or monitor mode, as described next in connection with FIG. 6. Otherwise, the master device can provide further assistance to boot the rest of the devices connected to the host computer.

The master device provides the host computer with a starting address from which the code within the transferred image starts execution. The host starts the image now loaded into its RAM 214. The host can then run whatever code was loaded in its RAM, such as an embedded single file application or a general purpose operating system. Special drivers included in the host's image can redirect the host computer's console output to the master device for administrative control. Also, if a unified configuration mechanism is used, the host computer may notify the master device of applicable extensions (like command line interface grammars, and MIB trees) that are usable with the configuration mechanism. Once the host applications have been started, the host is in an operative mode, as described more fully below in connection with FIG. 7.

During normal operating conditions, after power-on or reset, the microprocessor 322 of the master device executes the code in the primary memory 326 and RAM 324. This code serves as an embedded operating system, and causes a pre-selected startup configuration to be read. Preferably, the startup configuration is read either from the configuration memory 336 or from the storage module 312 or from a remote storage device connected, for example, to the network adapter 380. The microprocessor 322 then reads a host software image from the storage module 312 and transfers the image into memory 215 of the host computer across the extension bus 216. The microcontroller 332 automatically defaults to the upgrade mode 420 if the attempt to start in normal mode fails (usually due to an inappropriate content of the primary memory 326).

This start-up procedure concerns normal behavior of the host computer and master device. The master device can be powered by an auxiliary source and therefore should be up and running and have full control of the host computer. If anything happens during startup (e.g. image is not found or is corrupted or does not start properly, etc.), the master device can inform (via syslog entries or SNMP traps) a remote device or network operation center (NOC) of the abnormal situation. Administrators can access the master device from a remote location, diagnose the problem, and load a new version of the host image into the master and perform a controlled reload of the host computer. Thus, the host image can be upgraded as desired with minimum service interruption. The steps for implementing an upgrade or modification to the host image are as follows: the operator remotely logs into the master device 220 through a secure domain or console, copies a new image from the remote storage device to the local solid state storage 312), changes the file name in the configuration to define that file as the boot file, and restarts the master device and host computer. If something goes awry with the new image, the administrator can boot the prior image instead and diagnose the problematic host image off-line on a different machine. Note that several images can be tested successively, without the need of reinstalling operating systems and applications, simply by selecting another file to boot the host (that is, by changing the boot file name). Thus, for example, if the corruption was to the host computer's file system, normal system operation is readily restored by rebooting because the master device shall recreate an error-free file system, with all the files in their original state.

Some applications handle large amounts of data, requiring the use of hard disks on the host computer. However, because these disks should contain only data, a failure of such hardware will not prevent the host operating system from starting up.

An administrator can download a “Service” host image that contains utilities and repair or reformat the corrupted hard disk and, if successful, then he changes back the boot file with the original host image and restarts normal operation.

FIG. 6 illustrates operation of the master device 220 monitor mode. In this mode, the master device is operative to monitor the continued operation of the host and also to support interactive sessions with an administrator through a console, telnet, ssh, web, or SNMP interface. At step 602, a test is made to determine whether the host is alive (e.g. by a heartbeat signal that has been received from the host computer within a prescribed time period).

The microcontroller 332 serves as a watchdog, monitoring at step 660 for a heartbeat signal from the master device and issuing at step 662 a reset signal to the host and master if the heartbeat is not detected within a prescribed interval. Optionally, an alarm signal can also be used to drive external circuitry such as a light or horn to advise persons in the vicinity of these machines that an abnormal condition has arisen.

The master device repeatedly tests whether the host is alive as indicated by the decision loop 602. Additional system checks regarding the operation of the master device or the host computer can be included in the loop 602, as desired, and the tests can be performed at different intervals (with some more frequent than others) and, consequently, in a different order than illustrated in FIG. 6. In the event that any of these tests has negative results, then a message can be sent at step 610 to an administrator or a system log entry can be created, or both to note the violation. Regardless of whether the violation is noted, at step 612, the host is restarted and, upon this restart, the master device 220 again locks the extension bus and performs the steps illustrated in FIG. 5 starting at step 501, including at least step 502 and steps 512 through 518.

With reference now to FIG. 7, the operation of the host computer 210 is described. Upon startup, the master device 220, being connected to the host computer through the extension bus 216, locks the extension bus and exposes its OROM boot code. While executing its POST code, the host computer identifies the presence of the master device and its status as the first boot device. At step 702, the host computer's own BIOS boot code is bypassed in favor of the OROM boot code of the master device. When the master device itself has booted, configured itself, then at step 704 the image is transferred into the host computer. The master device provides the host computer with a starting address for executing the code included in the transferred image, and, at step 706, the host computer initializes the host operating system and launches, as early as possible, the AppsMonitor module.

The transferred image typically includes an operating system as well as one or more applications that are to be run on the host computer 210. Preferably, each of these applications is launched using the AppsMonitor module, as indicated at step 708 and the AppsMonitor operates in the background monitoring the applications and collecting data on the health of the host computer, as indicated at step 710. AppsMonitor keeps track of processes under its control and automatically restarts processes that terminate unexpectedly. AppsMonitor optionally performs application specific probing procedures to measure the health of each application instance, if such probing procedures code exists in the host image. AppsMonitor also performs system wide preventive tasks, like checking the status of known process, measuring the CPU load, and other general resource utilization checks that are aimed to detect possible lock-ups and to prevent host crashes.

The data collected by the AppsMonitor module is compared against a prescribed criterion, at step 712. A test is made at step 714 to determine whether the collected data is within specification. The prescribed criterion can be a particular number of processes that are supposed to be active in the host computer, a size for given process, a particular load value on the CPU of the host computer, or some other criterion. If the data collected by AppsMonitor are not within specification, then, optionally, a message can be sent at step 716 to the master device for inclusion in the system log and/or forwarding to an administrator. A pre-determined action is taken by AppsMonitor at step 718 in view of the test result, such as terminating or restarting the active process. The process flow loops back to step 710 for collection of further data on the processes active on the host computer and further comparisons against prescribed criterion. If the condition detected is catastrophic (e.g. critical resources exhausted, inconsistent system status, intruder attack detected, repeated failure to restart the failed operation of critical processes, etc), AppsMonitor request the master device to initiate a restart procedure and a fresh instance of the host is shortly restored. On the other hand, if the comparison proved to be within specification, then, at step 730, the host computer provides an ‘is Alive’ signal across the extension bus 216 to the master device. The process flow loops back to step 710 to collect further data on active host processes. Meanwhile, the ‘is Alive’ info provided at step 730 is tested within the master device (at step 602) as part of the master's idle or monitor operating condition.

Shut-Down

Each time the host computer is started, a fresh copy of the intended image for the host computer is loaded by the master device 220. The front panel reset and power switch circuit paths are preferably intercepted by the microcontroller 332 to permit the CPU 322 to perform a clean shutdown and better preserve data that has been saved on disk or that is still in the host computer's memory. More specifically, CPU 322 sends commands to the AppsMonitor module, which is resident and executing in the host computer, and AppsMonitor responds to these signals to shut down active applications and processes. Thus, shutdowns are clean and never unexpected (unless host software hangs or power is lost).

Unified Configuration Mechanism

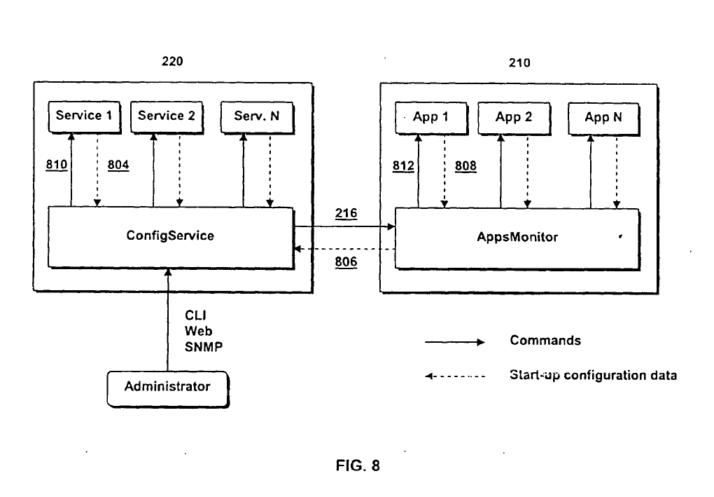

FIG. 8 illustrates the connectivity between the master device and the host computer at the configuration level. Remote maintenance of the host computer is achieved by providing commands to the ConfigService module of the master device through a set of standard user interfaces. The advantages of a unified configuration mechanism are a high degree of control over the configuration process and ease of use. A high degree of control also implies more reliability and security by reducing the risks of accidental or unauthorized configuration change. The commands are dispatched by ConfigService module either to the master device or to the host computer by forwarding the commands from the ConfigService module to the AppsMonitor. Thus, the same services can be used to cofigure both the master device and the host computer This way, an administrator can remotely access from the secure management domain, using a single entry point, either the master device or the host computer and not allow configuration and maintenance operations to the host computer from anywhere else. The operations that the administrator can perform remotely include: inspecting the status of active services and/or applications, changing the running configuration, saving the running configuration as startup configuration, copying files between the local solid state storage and remote storage devices, and initiating a restart. The selected configuration can be saved for later use (e.g., as the default image). Configurations can be saved locally within the master device or on a remote storage device. Likewise, the configuration can be edited remotely and again loaded or stored for execution upon restart or some later time. Preferably the host computer (or other network device) is configured using one startup configuration file and one executable host image file, each of which can be stored in the local solid state storage module 312. For increased reliability and availability, it is permitted to store the startup configuration file on a different physical device than the host image file. This minimizes the risk of loosing the image file (usually large, so a transfer from a remote storage device would result in a long outage) in the unlikely event of a failure while updating the configuration (e.g. a power failure during write). To simplify maintenance, a single configuration file can be used to store both master and host configuration data. With reference now to FIG. 8, the administrator provides commands over the communication line 802 to the master device 220 through an interface at the administrator's terminal (not shown). The command to be executed is parsed to identify the affected application or service, the function to be invoked and its arguments. At start-up, ConfigService retrieves configuration related data (grammars and MIBs) from local services running within the master device (see arrows 804). ConfigService then interrogates the AppsMonitor module running on the host computer for the host computer's configuration data. AppsMonitor retrieves configuration related data from the installed applications (grammars and MIBs; see arrows 808) and eventually forwards them to the ConfigService as shown by arrow 806. The master device can now construct a common configuration data structure and a dispatcher mechanism can instruct an affected application or service to execute the function in the command to be executed using the arguments that were provided. Commands are passed either to the services running in the master device, as shown by arrows 810, or on applications running on the host computer, as shown by arrows 812. Commands forwarded by the master device 220 to the host computer 210 are passed across the extension bus 216.

There are two types of commands that can be processed by the CLI module: commands that influence the running configuration (“config” commands) and commands that trigger actions, for example, display information or copy a file, without affecting the running configuration (“exec” commands). The consolidated relevant state of all the software running at a certain moment in time on the host computer and the master device is called a “configuration.” Internally a configuration is given by the values of “configuration variables.” The configuration variables are the internal variables that can be accessed by the management protocol in use, e.g., SNMP. Externally a configuration can be represented as a set of CLI configuration commands which, when applied to a freshly started machine, reproduce the state of the software at that given moment. Each application or service that implements configuration commands must also be able to generate its current configuration at any given moment in time as a sequence of CLI configuration commands. The complete running configuration is obtained by collecting and concatenating the current configuration from all the applications and services.

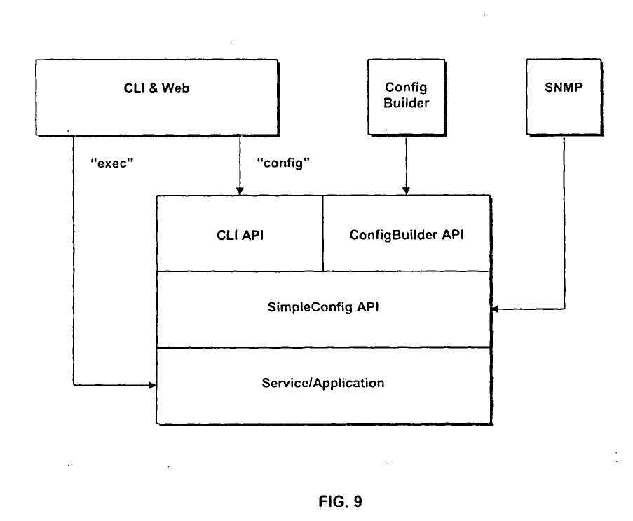

The configuration mechanism is structured as a three level application program interface (API) stack which prescribes the way in which a programmer writing an application program can make requests of a given service or application. As shown in FIG. 9, the bottom layer is included in each service or application and responds to “exec” commands. Above that layer, a SimpleConfig API implements simple read/write operations on single variables from the service or application space. Read operations on variables can be performed directly from the service or application space. Writing operations on variables is more complex, requiring a transactional approach in order to maintain consistency between sets of related variables, as understood by those of ski 11 in the art. The SimpleConfig API is used by the SNMP agent, and each SNMP variable has a corresponding service or application variable accessible with a read function and, if required, a write function. At the next level is the CLI API, called by the CLI and Web server modules, and the ConfigBuilder API. The ConfigBuilder API generates a set of commands that represents the current configuration. The applications and services in the master device and host computer can use the CLI API to enable configuration via the CLI and Web server modules as well. The functions in the CLI API can be “shallow wrappers” for functions in the Simple Config API, that is, functions associated with “config” commands merely set (write) and get (read) configuration variables using the Simple Config API without directly accessing the internal state of the application. Except when an error occurs, configuration functions ordinarily do not generate any output. “Exec” commands are passed directly to execution functions in the application and, depending on the function, can initiate a dialog with the user, generate an output and send the output to the user. The advantage of such a layered architecture is that, when properly used, it provides a common and consistent base for both CLI/Web interface and SNMP interface, enforcing the use of simple get/set operation instead of direct access from CLI/Web to the internal configuration of services/applications. Used rigorously, this mechanism prevents situations in which specific configuration changes are possible only from CLI/Web and are not possible from SNMP.

Although designed with a high degree of generality, a single configuration file mechanism is not always suitable for applications that require large files having complex syntax. As an alternative, specific configuration files can be retrieved from a remote storage device as needed. To increase security, applications preferably request configuration files through the master device rather than through a public network. The master device optionally maintains a list of URLs identifying the location of a file to be retrieved and the host computer requests the configuration file using a name (e.g., a name corresponding to the URL). Also, the master can retain a cached copy of the configuration file in its solid state storage which permits start up even when an otherwise required remote storage device is not available.

Remote Administration

Through the console 60 or the network adapter port 380, an administrator can modify, update, swap and debug configuration files and images from a remote location by providing commands to the master device as described above. Access is through a dedicated (preferably high-speed) port which is isolated from the host computer 210. An administrator can access and interact with the master device, or have messages pushed to him or her, in order to, among other things:

1. Be advised of the status of the host computer 210 or the master device 220. For example, the AppsMonitor module can push a message advising the administrator of a restarted application, lack of resources on the host, missing ‘is Alive’ signals, etc.

2. Investigate the status of processes executing on the host computer such as review the status of host applications, resource utilization, trace the connectivity of users, trace delays between routers, obtain the temperature inside the cabinet containing the host computer, etc.

3. Download host images or configuration files to the master device, as desired or required.

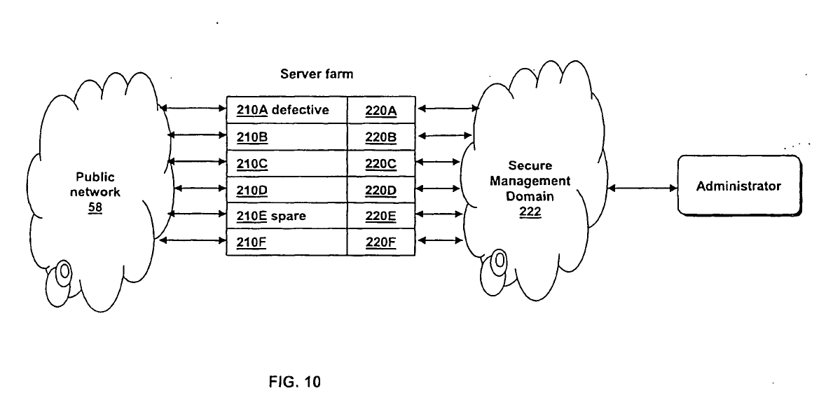

4. Employ utilities to address data integrity, hardware and software issues including dramatic reconfigurations of hardware components as illustrated in connection with FIG. 10, discussed below.

5. Upgrade, modify or replace the software modules in the master device.

6. Upgrade, modify or replace the host configuration, master configuration (e.g., change the IP address to include the master device in a different network or network segment) and the host computer's operating system and applications image file.

For sophisticated applications, multiple host computers (e.g., servers) can be fitted with master devices accessed by the administrator through a secure management domain 222. In the event of hardware or software failure, excessive loads on a given host computer's CPU 212, an underutilized CPU, unauthorized attack on a host computer, or other situation, the administrator can effect a change in the configuration of master devices to minimize server downtime. FIG. 10 illustrates a server farm including a plurality of host computers 210A, . . . , 210F and a corresponding set of master devices 220A, . . . , 220F (more generally referred to as host computers 210 and master devices 220). The host computers 210 are all connected to a public network for bidirectional communication and to the master devices over a respective extension bus 216. The master devices, in turn, are shown as being connected to a secure management domain which directs commands and functions received from the administrator. An initial configuration of the server farm might be as shown in the table below.

| Server | Master |
|---|---|
| 210A (active) | 220A |
| 210B (active) | 220B |
| 210C (active) | 220C |
| 210D (active) | 220D |
| 210E (spare) | 220E |
| 210F (active) | 220F |

At some point in time, server 210A might experience a failure of one kind or another and become unavailable to users attempting to access that machine over the public network 58. If the server 210A supported commercial transactions, for example, the loss of that server can be associated with significant lost opportunities until its functionality is restored. The master device 210A, however, likely was unaffected by the loss of the server 210A, and has the startup configuration and host image necessary to boot another machine in lieu of server 210A.

In this embodiment of the invention, the administrator can invoke a spare server 210E to perform the functionality of crashed server 210A by downloading the requisite images from master device 220A into master device 220E via a temporary remote storage device. As a result of invoking spare server 210E, the new configuration of the server farm would be:

| Server | Master |
|---|---|
| 210A (crashed) | 220A, idle |
| 210B (active) | 220B |
| 210C (active) | 220C |
| 210D (active) | 220D |
| 210E (active) | 220E, using config and host image from 220A |
| 210F (active) | 220F |

In like manner, underutilized machines can be swapped for overutilized machines and other rearrangements can be made by the administrator through the CLI API. By updating the configuration of the masters and downloading host images, the administrator can readily reconfigure publicly exposed machines through a secure channel.

In alternative embodiments, there need not be one-to-one correspondence between the number of host computers 210 and master devices 220.

Standalone Master Architecture

The above embodiment included a smart microprocessor-based PCI device connected to a PCI bus on a mainboard; however, another functionally equivalent embodiment can be arranged in which a standalone device can boot and manage a plurality of host computers, as shown in FIG. 11.

The standalone master device 220′ is almost identical to the device presented in FIG. 3, except the bus adapter 302 does not need to be connected to an external bus and all devices present on the high speed local peripheral bus are local to the processor 322.

The network adapter 380 is connected to the secure management domain 222 and, one of high speed interfaces 392 is connected to the internal network 1110.

Each host computer 210 has an interface 1130 connected to the internal network 1110. This interface is functionally equivalent to managed network interfaces, i.e., it has a network driver and includes logic to differentiate management traffic from regular traffic and to divert management traffic to a separate management bus. In a typical configuration, the internal network is a 10/100 Mbps Ethernet segment, and 1130 interfaces are managed Ethernet cards.

Reset/Power-on functions are generated by the appliance 220′, routed to the corresponding 1130 interface and diverted to management circuitry in the host.

At reset, the host BIOS initiates a standard network boot procedure. The appliance 220′ serves as a network boot server (e.g. DHCP/BOOTP server) and transfers a piece of code equivalent with the OROM code in the master devices; this piece of code further downloads the single file host image to the host to the master.

After the host operating system is loaded and AppsMonitor is initiated, communication between the host and the master is carried on by the Internal network 1110 using the same high-level protocol as in the local master device case.

As mentioned before, from a functional point of view this embodiment is equivalent to having the master device installed within a host computer. The major difference between these two arrangements is that direct access to host memory from the master is available only in the local master device 220 case.

The functional equivalence can go as far as allowing the use of common host images and host startup configurations in both embodiments.

For supplementary redundancy, each host can contain multiple such 1130 interfaces, connected each to a separated internal network; all these networks are connected to multiple distinct appliances, each with multiple dedicated interfaces. The configuration in the appliances defines a hierarchy, with one primary device and multiple secondary/cache devices, that automatically take over functionality in case of failure.

Final Considerations

In summary, the master device is provided to reliably boot the host computer by storing the image to be executed on the host computer outside of any publicly exposed areas. This makes the image immune to hardware and software failures as well as viruses, regardless what happens (except, of course, for major hardware failures which can be addressed through machine swapping techniques discussed above). The master device also provides a reliable and secure maintenance path for monitoring and software upgrades. This is achieved by completely relieving the host computer's processor (which is accessible to the public network) from all maintenance chores and boot functions and instead assigning them to the master device's processor. The master device is accessible only through a secure management domain and so no action performed on the host or initiated from the public network can change the startup configuration or the host image. Consequently, the host always starts in the same deterministic way.

It is believed to be impossible for intruders compromising the host computer's software to get access to the running environment or image storage devices of the master. The host has all its power available for a single purpose: to offer secure services via its public network interfaces.

The master device, therefore, provides full remote control over the network device configuration and to allow the administrator to easily download a new host image from a remote storage device. A network appliance fitted with a master device of the invention can implement such mechanisms on the host (like having a strict control on the execution of the applications, excluding daemons/services/sockets intended to permit administrative access from the public network) to increase the reliability and availability of all host applications. Assuming the hardware functions properly and that a) the master device has access to a startup configuration, b) the solid state storage contains the host image, and c) the primary memory on the master contains the master monitor code, then the master device will automatically boot the host at power up or reset, always and without exception. On the other hand, manual operation (that is, remote maintenance and disaster recovery) can be initiated: a) if the startup configuration on the local storage gets corrupted or the files on the remote storage device are no longer accessible by permitting the operator to either copy a startup configuration file from a backup storage device or manually recreate the configuration, b) if the host image on the solid storage gets corrupted by permitting the operator to either select a backup image on a secondary solid state storage module or download a fresh image from a remote storage device, and c) if the primary memory on the master gets corrupted (e.g. during an unsuccessful upgrade) by pre-programming the microcontroller to automatically switch the master to upgrade mode so that a remote operator can retry the upgrade. Since the upgrade monitor code and the microcontroller code are factory programmed (i.e. impossible to reprogram on-board) remote control via the console will always be available and full recovery is guaranteed.

Optionally, software objects are defined that can be manipulated through a graphical interface to have properties and methods that correspond to or emulate the real-world physical devices that they represent to facilitate an update by an administrator.

Having described specific preferred embodiment of the present invention with reference to the accompanying drawings, it is to be understood that the invention is not limited to this precise embodiment, and that various changes and modifications may be effected therein by one skilled in the art without departing from the scope or the spirit of the invention.

We claim:

1. A method for providing a secure operation of a host computer that comprises the steps of:
connecting to the host computer a master device having a CPU configured to execute a monitor program and to manage one or more host images and the host computer;
bypassing a bootstrap code native to the host computer and executing a master-device supplied bootstrap code instead;
establishing a communication channel between the master device and the host computer, communications between the master device and the host computer being governed by the CPU of the master device;
transferring from the master device a selected one of the host images over the communication channel to the host computer;
instructing the host computer to execute the transferred host image;
actively monitoring the functionality of the host computer via the monitor program of the master device by comparing a set of operational parameters obtained from the host computer against a prescribed set of values within a prescribed period of time; and
on the basis of the monitored comparison, selectively restarting the host computer to thereby maintain the secure operation of the host computer.

2. The method as in claim 1, including the additional step of providing the master device with full remote control mechanism.

3. The method as in claim 2, wherein the full remote control mechanism is only accessible by means of a secure connection.

4. The method as in claim 2, wherein the full remote control mechanism includes a failsafe software upgrade function.

5. The method as in claim 2, wherein the full remote control mechanism is extended to the host computer.

6. The method as in claim 2, wherein the full remote control mechanism includes a command line interface (CLI).

7. The method as in claim 2, wherein the full remote control mechanism includes a SNMP agent.

8. The method as in claim 2, wherein the full remote control mechanism includes a HTTP server.

9. The method as in claim 1, wherein the active monitoring step is performed by the CPU of the master device.

10. The method as in claim 1, wherein the set of operational parameters obtained from the host computer comprises a heartbeat signal conveyed to the master device at a prescribed interval.

11. The method as in claim 9, wherein the set of operational parameters obtained from the host computer comprises a portion of the host computer memory and the prescribed set of values comprise a predefined content.

12. The method as in claim 1, wherein the master device is a subsystem of the host computer.

13. The method as in claim 12 wherein the connection of the master device comprises integrated circuitry on a mainboard of the host computer.

14. The method as in claim 12 wherein the host computer has an extension bus and wherein the master device is an extension board attached to the extension bus of the host computer.

15. The method as in claim 12, including the additional step, prior to the bypassing step, of exposing bootstrap code within the master device to the host computer across the extension bus.

16. The method as in claim 15, wherein the master-device supplied bootstrap code is stored in the master device within option ROM.

17. The method as in claim 15, wherein the bootstrap code is exposed by an address translation unit within the master device.

18. The method as in claim 1, wherein the bypassing step comprises executing in the host computer the master-device supplied bootstrap code.

19. The method as in claim 1, wherein the master device is a standalone network device configurable to manage one or more host computers.

20. The method as in claim 19, wherein the connection between the master device and the host computer comprises a local network segment and an inter-chassis management bus.

21. The method as in claim 19, wherein the connection between the master device and the host computer comprises a local network segment that conveys both normal network traffic and inter-chassis management traffic.

22. The method as in claim 19, wherein a booting protocol of the master-device supplied bootstrap code is a standard network boot protocol.

23. The method as in claim 1, wherein the master device includes one or more storage devices for storing the host images and startup configuration data.

24. The method as in claim 23, wherein the startup configuration data and the host images are stored on discrete storage devices.

25. The method as in claim 23, further including the step of selecting a host image containing an operating system and applications from the storage device on the basis of the startup configuration data.

26. The method as in claim 23, further including the step of selecting a host image containing an operating system and applications from the storage device on the basis of a command received from a remote machine connected to the master device through a communication link.

27. The method as in claim 1, wherein the host images are stored on storage devices that are remote from the master device.

28. The method as in claim 1, wherein the startup configuration data is stored on storage devices that are remote from the master device.

29. The method as in claim 1, wherein the transferred host image contains an embedded application.

30. The method as in claim 1, wherein the transferred host image contains an operating system and applications.

31. The method as in claim 1, wherein the connection between the master device and the host computer permits transferring data from one or more storage devices connected to the master device into the host computer and precludes modification initiated from the host computer of data on one or more storage devices connected to the master device.

32. The method as in claim 1, wherein the bypassed bootstrap code native to the host computer is the BIOS boot code of the host computer.

33. The method as in claim 1, wherein the transferring step comprises transferring the selected host image to the host computer in a compressed format.

34. The method as in claim 33, including the additional step of decompressing the transferred image within the host computer.

35. The method as in claim 33, wherein the transferred image is encrypted and wherein the master device transfers a decryption algorithm to the host computer for decrypting the transferred image within the host computer.

36. The method as in claim 35, including the additional step of decompressing the transferred image within the host computer.

37. The method as in claim 1, wherein the transferred image is encrypted and wherein the master device transfers a decryption algorithm to the host computer for decrypting the transferred image within the host computer.

38. The method as in claim 1, including the additional step of configuring the host computer.

39. The method as in claim 38, including the additional step of providing configuration data to the host computer from the master device, wherein the step of configuring is exclusively in accordance with the provided configuration data provided from the master device or is only partially in accordance with the provided configuration data provided from the master device.

40. The method as in claim 39, wherein the configuration data is provided to the master device from a storage device within the master device.

41. The method as in claim 39, wherein the configuration data is provided to the master device from a remote storage device connected to the master device through a communication link.

42. The method as in claim 39, wherein the step of configuring is made on the basis of one or more commands received from a remote machine connected to the master device through a communication link.

43. The method as in claim 38, including the additional steps of retrieving running configuration data from one or more host computers and storing said data on one or more storage devices connected to the master device.

44. The method as in claim 1, wherein the step of selectively restarting the host computer comprises sending a reset signal to the host computer.

45. The method as in claim 44, wherein the reset signal is generated by a microcontroller within the master device.

46. The method as in claim 44, wherein the reset signal is conveyed to the host computer via a management bus.

47. A method for providing a secure operation of one or more active processes executing on a host computer, comprising the steps of:
connecting to the host computer a master device having a CPU configured to execute a monitor program and to manage one or more host images and the host computer;
bypassing a bootstrap code native to the host computer and executing a master-device supplied bootstrap code instead;
establishing a communication channel between the master device and the host computer, communications between the master device and the host computer being governed by the CPU of the master device;
transferring from the master device a selected one of the host images over the communication channel to the host computer;
instructing the host computer to execute the transferred host image;
executing one or more active processes on the host computer;
determining if any of the active processes is operating outside of prescribed parameters; and
on the basis of the determining step, selectively restarting one or more of the active processes to thereby maintain the secure operation of the host computer.

48. The method as in claim 47, including the additional step of providing the master device with full remote control mechanism.

49. The method as in claim 48, wherein the full remote control mechanism is only accessible by means of a secure connection.

50. The method as in claim 48, wherein the full remote control mechanism includes a failsafe software upgrade function.

51. The method as in claim 48, wherein the full remote control mechanism is extended to the host computer.

52. The method as in claim 48, wherein the full remote control mechanism includes a command line interface (CLI).

53. The method as in claim 48, wherein the full remote control mechanism includes a SNMP agent.

54. The method as in claim 48, wherein the full remote control mechanism includes a HTTP server.

55. The method as in claim 47, wherein the active monitoring step is performed by the CPU of the master device.

56. The method as in claim 47, wherein the set of operational parameters obtained from the host computer comprises a heartbeat signal conveyed to the master device at a prescribed interval.

57. The method as in claim 55, wherein the set of operational parameters obtained from the host computer comprises a portion of the host computer memory and the prescribed set of values comprise a predefined content.

58. The method as in claim 47, wherein the master device is a subsystem of the host computer.

59. The method as in claim 58, wherein the connection of the master device to the host computer comprises integrated circuitry on a mainboard of the host computer.

60. The method as in claim 58, wherein the host computer has an extension bus and wherein the master device is an extension board attached to the extension bus of the host computer.

61. The method as in claim 58, including the additional step, prior to the bypassing step, of exposing bootstrap code within the master device to the host computer across the extension bus.

62. The method as in claim 61, wherein the master-device supplied bootstrap code is stored in the master device within option ROM.

63. The method as in claim 61, wherein the bootstrap code is exposed by an address translation unit within the master device.

64. The method as in claim 47, wherein the bypassing step comprises executing in the host computer the master-device supplied bootstrap code.

65. The method as in claim 47, wherein the master device is a standalone network device configurable to manage one or more host computers.

66. The method as in claim 65, wherein the connection between the master device and the host computer comprises a local network segment and an inter-chassis management bus.

67. The method as in claim 65, wherein the connection between the master device and the host computer comprises a local network segment that conveys both normal network traffic and inter-chassis management traffic.

68. The method as in claim 65, wherein a booting protocol of the master-device supplied bootstrap code is a standard network boot protocol.

69. The method as in claim 47, wherein the master device includes one or more storage devices for storing the host images and startup configuration data.

70. The method as in claim 69, wherein the startup configuration data and the host images are stored on discrete storage devices.

71. The method as in claim 69, further including the step of selecting a host image containing an operating system and applications from the storage device on the basis of the startup configuration data.

72. The method as in claim 69, further including the step of selecting a host image containing an operating system and applications from the storage device on the basis of a command received from a remote machine connected to the master device through a communication link.

73. The method as in claim 47, wherein the host images are stored on storage devices that are remote from the master device.

74. The method as in claim 47, wherein the startup configuration data is stored on storage devices that are remote from the master device.

75. The method as in claim 47, wherein the transferred host image contains an embedded application.

76. The method as in claim 47, wherein the transferred host image contains an operating system and applications.

77. The method as in claim 47, wherein the connection between the master device and the host computer permits transferring data from one or more storage devices connected to the master device into the host computer and precludes modification initiated from the host computer of data on one or more storage devices connected to the master device.

78. The method as in claim 47, wherein the bypassed bootstrap code native to the host computer is the BIOS boot code of the host computer.

79. The method as in claim 47, wherein the transferring step comprises transferring the selected host image to the host computer in a compressed format.

80. The method as in claim 79, including the additional step of the comprising the transferred image within the host computer.

81. The method as in claim 79, wherein the transferred image is encrypted and wherein the master device transfers a decryption algorithm to the host computer for decrypting the transferred image within the host computer.

82. The method as in claim 81, including the additional step of decompressing the transferred image within the host computer.

83. The method as in claim 47, wherein the transferred image is encrypted and wherein the master device transfers a decryption algorithm to the host computer for decrypting the transferred image within the host computer.

84. The method as in claim 47, including the additional step of configuring the host computer.

85. The method as in claim 84, including the additional step of providing configuration data to the host computer from the master device, wherein the step of configuring is exclusively in accordance with the provided configuration data provided from the master device or is only partially in accordance with the provided configuration data provided from the master device.

86. The method as in claim 85, wherein the configuration data is provided to the master device from a storage device within the master device.

87. The method as in claim 85, wherein the configuration data is provided to the master device from a remote storage device connected to the master device through a communication link.

88. The method as in claim 85, wherein the step of configuring is made on the basis of one or more commands received from a remote machine connected to the master device through a communication link.

89. The method as in claim 84, including the additional steps of retrieving running configuration data from one or more host computers and storing said data on one or more storage devices connected to the master device.

90. The method as in claim 47, wherein the step of selectively restarting the one or more of the active processes comprises sending a reset signal to the host computer.

91. The method as in claim 90, wherein the reset signal is generated by a microcontroller within the master device.

92. The method as in claim 90, wherein the reset signal is conveyed to the host computer via a management bus.
